(19) United States
(12) Patent Application Publication
(10) Pub. No.: US 2006/0255588 A1
(43) Pub. Date: Nov. 16, 2006

(54) Adjustable plumbing fitting apparatus and method

(76) Inventor: Mike Graybeal, Bloomington, IL (US)

Correspondence Address: HUSCH & EPPENBERGER, LLC, 190 CARONDELET PLAZA, SUITE 600, ST. LOUIS, MO, 63105-3441, US

(21) Appl. No.: 11/127,413

(22) Filed: May 12, 2005

(51) Int. Cl. F16L 39/00

(52) U.S. Cl. 285/131.1

(57) ABSTRACT

The present invention includes an adaptive slip joint coupling for connecting a fixture exit pipe to a wall pipe and also includes a system of couplings of varying dimensions, both providing for adaptable connections.

### CROSS-REFERENCE TO RELATED APPLICATIONS

None.

### BACKGROUND OF THE INVENTION

1. Field of the Invention

The present invention is adjustable fitting apparatus and system for plumbing, particularly for low pressure drain/waste/vent (“DWV”) plumbing.

2. Related Art

There is a constant need in the plumbing arts to match plumbing fittings, particularly between an external fixture in a room and the drain, waste or vent pipes hidden behind the walls of the room. At least for the visible portion, there is a constant need that the fittings be made as visually appealing as possible. There is a further need for economy in the number of parts used, as well as economy in time and work required to complete an acceptable result.

Efficient fitting in plumbing is always desirable, particularly in DWV plumbing, and most especially for the type of construction that has become typical, that is to say, frame and drywall construction. Efficient fitting of plumbing fixtures to wall plumbing has been complicated by the fact that on typical construction projects the plumber and carpenter are on premise working on the same room at different times. Matching fittings can also be complicated by the very small amount of space within the wall for plumbing pipes and fixtures; space that might otherwise be available for adjustment. A commonplace situation is as follows: a building, either commercial or residential, is framed by a carpenter. A plumber will install plumbing lines within the walls that have been framed. Thereafter another carpenter or drywaller will follow and put the finish drywall on the frame, leaving a small hole allowing access to the pipes installed there previously by the plumber. After this step, another plumber returns to attach fixtures such as toilets, sinks and the like to the pipe in the wall, through the hole left in it for that purpose by the carpenter. It frequently happens that the fixture dimensions and/or changes in the wall dimensions made by the carpenter do not allow a properly fit in connection between the exit pipes of the fixture and the wall pipe. For example, carpenters sometimes move the wall out from the position indicated for it when the first plumber installed the wall pipes. For another example, the fixture might have a different dimension than planned for originally. A result of these events is that an unplanned for extension of the wall pipe must be created by the second plumber in order to adequately connect the fixture pipe in the room to the wall pipe provided for it.

Such adjustments are disadvantageous for at least two reasons. First, the extension fittings commonly available, most particularly typical PVC pipe and fixtures, must be on the room side of the wall and are frequently too large to be covered up by the escutcheon provided for it. Secondly, the second plumber must take extra time, frequently on the order of an hour, to install extension fittings. Moreover, simply in order to achieve the extension fitting to complete the installation, the second plumber sometime has to cut a large square hole in the wall for sufficient access to the wall pipes. Thereafter, the carpenter must return in order to patch the hole in the wall, requiring another one to three hours of work.

Presently in the art there is a series of adapters and slip joint couplings having a variety of male and female threaded and nonthreaded fitting arrangements. None of the presently available fittings are adjustable or variable in the desirable dimensions. None of the presently available fitting systems provide a direct, threaded, sealing joint that can be adapted to the type of unanticipated dimension changes described above. Hence, there is a need in the art for a system providing a variety of threaded slip joint coupling dimensions, and/or an adjustable fitting adaptable to a variety of dimensions.

### SUMMARY OF THE INVENTION

The present invention includes an adaptive slip joint coupling for connecting a fixture exit pipe to a wall pipe and also includes a system of slip joint couplings, T fixtures and a quarter bend fixtures of varying dimensions, both providing for adaptable connections.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a T fitting having a male threaded throat;

FIG. 2 is a cross section view of a female threaded slip joint adjustable coupling;

FIG. 3 is a double T fitting;

FIG. 4 is a double 90 fitting; and

FIG. 5 is cross sectional view of a system of variously dimensioned female threaded slip joint couplings.

### DETAILED DESCRIPTION OF THE PREFERRED EMBODIMENTS

The following description of the preferred embodiment(s) is merely exemplary in nature and is in no way intended to limit the invention, its application, or uses.

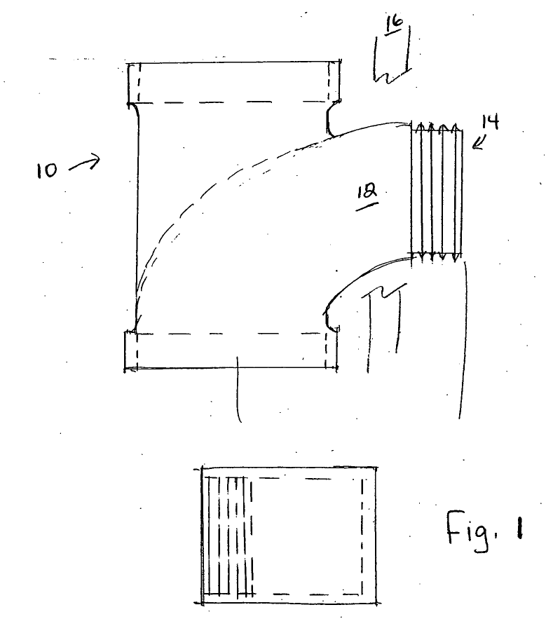

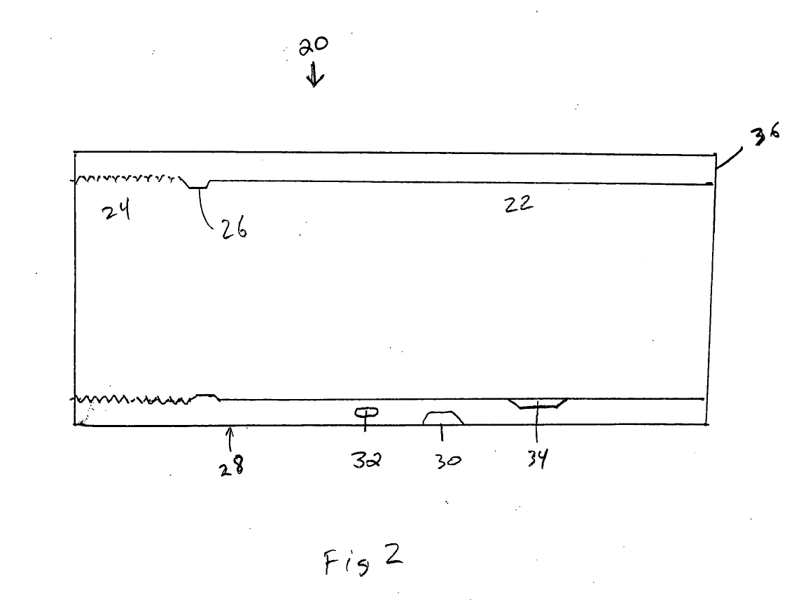

FIG. 1 depicts a T-fitting 10 having a throat 12 having an aperture with male threads 14 on the outside. A wall 16 is presented in cross section to indicate the anticipated installed position of the T-fitting 10. FIG. 2 is a cutaway version of an adjustable slip joint coupling having a female thread on its internal diameter. Female coupling 20 is comprised of an unthreaded extension 22 providing length that can be varied for adjustment. The threaded internal diameter 24 comprises a female portion dimensioned to threadingly engage male portion 14 of the T-fixture or other fixtures. A seal abutment 26 separating the threaded portion 24 and non-threaded portion 22 is provided for seating of a seal (not shown) in order to apply a water tight seal between an end of the fixture exit pipe, such as a P-trap pipe, and the male portion of the T or other fixture. The outer diameter of the adjustable slip joint coupling 20 may include a marker 28 just behind the location of the lip 26 on the internal diameter. This marker will indicate to a plumber that portion of the non-threaded length 22 of the coupling that is the extension which may be cut for adjustment.

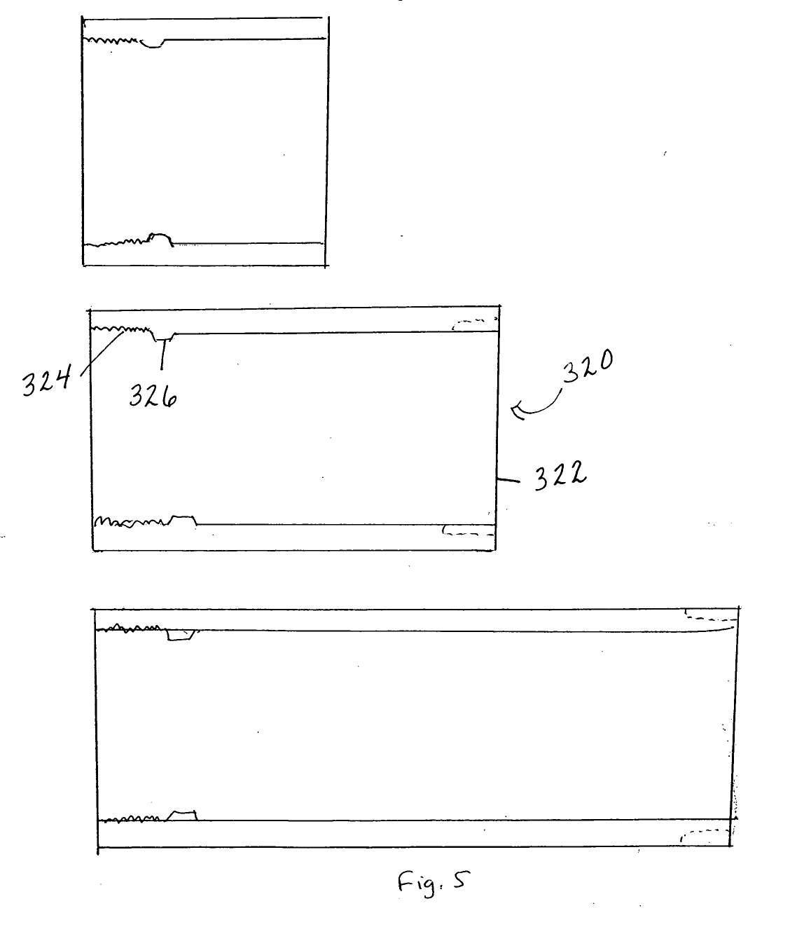

In operation, the female slip joint coupling 20 will be measured by the plumber and cut with any of a variety of standard pipe cutters at any selectable place in the unthreaded portion 22 of the coupling. The plumber may cut through a standard thickness of the coupling wall, as indicated on the top portion of FIG. 2. Alternatively, the female coupling 20 may be fabricated such that preconfigured thin or weak portions of the coupling wall be included, such as notches or grooves on outside diameter 30, on an inside diameter 34, or hollow portions within the thickness of the coupling wall 32. For hollow portions 32 and internal diameter thin portions 34, one may alternatively include markers on the outside diameter indicating where these positions are. Alternatively, pieces could be screwed or glued together, using joining interfaces such as those shown on the top of FIG. 5.

Having measured and cut the adjustable female slip joint coupling 20 to an appropriate length, the fixture exit pipe or P-trap pipe is inserted through female slip joint coupling 20, through a standard seal and then into throat 12 of T-fitting 10. The plumber then slides the female slip joint coupling 20 along the P-trap pipe until it engages male threads 14 on throat 12, whereupon the plumber screws the coupling in. Having adjusted the female coupling 22 an appropriate length, any escutcheon or other fixture provided will appropriately fit over end portion 36 of female coupling 20, thereby providing an esthetically acceptable finish.

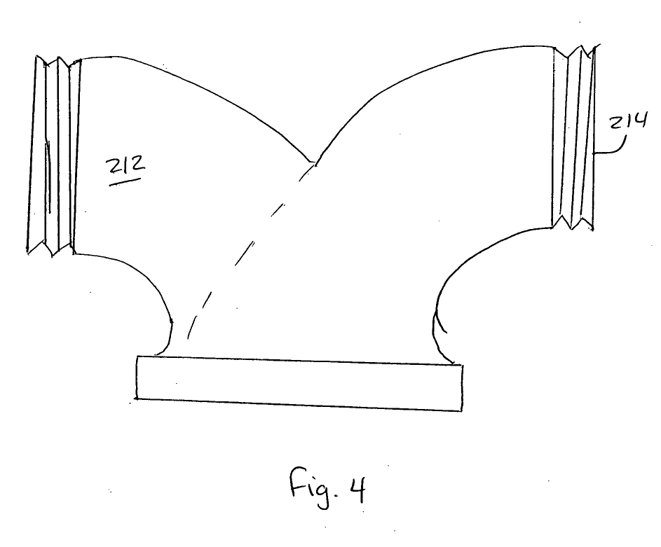

FIG. 4 shows a double throated T-fitting, each throat 112 having male threads 114. FIG. 5 shows a double threaded 90 fitting, which may also have the male threads of the present invention, 214. A single 90 having a male thread 214 is indicated on the right hand side of FIG. 4 in a profile corresponding to the phantom line in that figure.

The adjustable slip joint female threaded coupling of the present invention may mate with any of the depicted single throat T-fixture, double throat T-fixture, single throat 90 or double throat 90. Either or both of the fittings herein described may be made of any material, including cast iron, steel, plastic, and particularly polyvinylchloride (PVC).

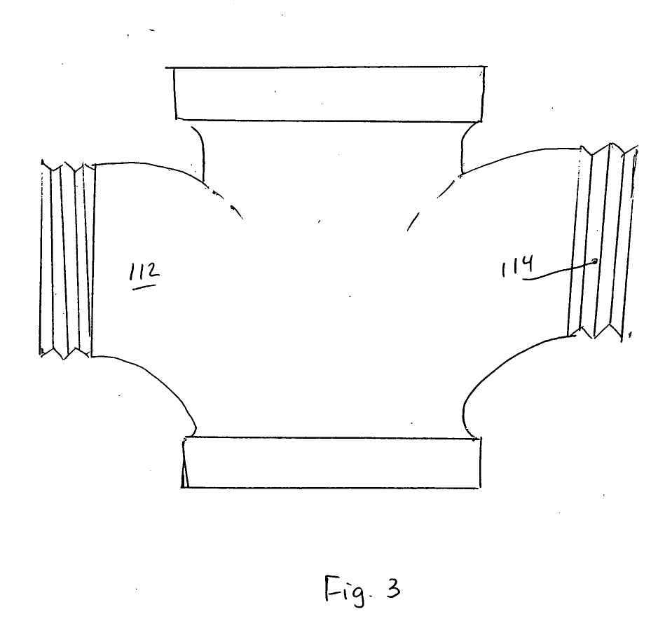

FIG. 3 shows an alternate system wherein the adjustable female slip joint couplings 320 are each at a different length. The female threaded portions 324 and lips 326 are the same as depicted in FIG. 2. However, the unthreaded portion 322 is a different length for each of the depicted examples. Accordingly, in operation, the system of the present invention would include a plumber having various lengths of female threaded slip joint couplings in his tool box. When presented with a mismatched dimension for joining a fixture exit pipe with the wall pipe fitting when the wall pipe fitting is behind the wall, the plumber may choose the length of female threaded coupling 320 best suited for the dimensions at hand and proceed to fit the fixture with that selected coupling.

This invention eliminates one and sometimes two pieces normally needed for installation of plumbing fixture to wall pipe. It eliminates the need to carry a saw, PVC cleaner and PVC glue when setting fixtures and saves labor and material.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A drain, waste, vent plumbing fixture comprising:
a first aperture oriented in a first direction, said first aperture being adapted for joinder with a pipe;
a second aperture oriented in a second direction, said second direction being non-parallel with said first direction;
a through hole from said first aperture to said second aperture, said through hole being adapted to define a fluid communication path from said first aperture to said second aperture;
said second aperture being circumscribed by an aperture wall having an external thread, said external thread being adapted for a screw fitting with a coupling having an internal female thread; and
said aperture wall being further adapted to seal fluid upon installation with a seal and with the coupling.

2. The fixture of claim 1 wherein said fixture is made of polyvinyl chloride.

3. The fixture of claim 1 wherein said fixture is selected from the group consisting of a T-fitting, a double T-fitting, 90 and a double 90.

4. An adaptive coupling for a drain waste vent fitting comprising:
a coupling, said coupling having an interior, female thread at a first end;
a seal abutment, said seal abutment being on an interior wall of said coupling and said seal abutment being disposed to create a fluid seal with a seal ring upon installation of said coupling, and said seal abutment approximate to said interior female thread;
an extension, said extension extending opposite said first end, said extension being adapted for a slip fit with an adjoining pipe;
said extension being longer from said seal abutment to an extension end than an axial thread length from said seal abutment to said first end, such that a length of said extension is adjustable by cutting said extension.

5. The adapted coupling of claim 4 further comprising preconfigured circumferential weak portions and a wall of said extension.

6. The adapted coupling of claim 5 wherein said preconfigured circumferential weak portions are selected from the group comprising: a notch, a groove, a thin wall portion, a detent, an interior hole in said extension wall.

7. The adapted coupling of claim 4 wherein said coupling is made of polyvinyl chloride.

8. The adapted coupling of claim 4 wherein a marker on an external wall of said adapted coupling indicates a position of said seal abutment.

9. The adapted coupling of claim 5 wherein at least one marker indicate on an exterior wall of said coupling indicates a position of at least one of said weak portions.

10. A method of fitting drain waste and vent fixtures to interior wall plumbing comprising:
installing a pipe in wall space, said pipe having a fixture with an aperture disposed beyond a wall boundary;
providing said fixture having a first joining interface at said aperture;
disposing a room fixture at a preconfigured distance from the wall boundary;
matching said disposition of said aperture with a slip joint coupling, said slip joint coupling, said slip joint coupling having an extension and a second joining interface, said extension opposing said second joining interface, said slip joint coupling being selected from a plurality of slip joint couplings having various extension lengths such that a selective extension length is dimensioned to match said aperture to the pipe provided with the room fixture;
joining said aperture and said slip joint coupling with a fluid type seal there between; and
fixing said extension of said slip joint coupling to the pipe provided with the room fixture.

11. The method of claim 10 wherein said joining interface is first joining interfaces and male thread and said second joining interfaces a female thread.

12. The method of claim 10 wherein said joining interface is an abutment adapted for gluing.

13. The method of claim 10 wherein said joining interface is at least one screw fitting, said screw fitting being substantially parallel with an axis of said slip joint coupling.

14. The method of claim 10 wherein said slip joint coupling is made of polyvinyl chloride.
